(19) United States
(12) Patent Application Publication
(10) Pub. No.: US 2024/0004613 A1
(43) Pub. Date: Jan. 4, 2024

(54) STATISTICS SYSTEM FOR PREPARING TEMPLATES

(71) Applicant: Renato GIANELLA, São Paulo (BR)

(72) Inventor: Renato GIANELLA, São Paulo (BR)

(21) Appl. No.: 17/854,479

(22) Filed: Jun. 30, 2022

(51) Int. Cl. G06F 7/58

(52) U.S. Cl. CPC G06F 7/582

(57) ABSTRACT

This invention relates in particular to a form of generating colored templates for means performed by generating random numbers for prediction, such as a lottery draw, where a specific subset of numbers is selected from a defined set of numbers.

### FIELD OF APPLICATION

This invention is in the field of application referring to games with random number generation, such as raffles and various lotteries. More specifically, it addresses a system for generating statistics and templates relevant to prediction games, for use in mathematical models and presented in the form of tables with colors. These models show the point of equilibrium at each stage in the evolution of lottery drawings.

### BACKGROUND OF THE INVENTION

There are several applications based on the generation of random numbers, such as entertainment media that rely on a form of randomness to keep the user's attention and that generate a reward for that user depending on the result. Said random generation is the result of a sequence of numbers or symbols that cannot reasonably be predicted and that occur by uncertain chances, through a generation of random numbers by an electronic means or by the random selection of an object with an inscribed number or symbol. Various applications of randomness have led to the development of several different methods for generating random dice, some of which have been around since ancient times, among which are well-known “classical” examples, including dice rolling, coin flipping, shuffling cards, as well as numerous other techniques.

Over the centuries, mathematicians have constructed the Theory of Probability, initially using three mathematically pure steps and then adding other ideas which have been building up over time. The three steps were particularly:
Step 1: 1654—Pascal-Fermat. The famous correspondence between these two established the bases of the theory of probabilities (Pascal discovered the formulas for combinatorial analysis) which is the mathematical core of the concept of risk.
Step 2: In 1703, G. von Leibniz wrote to his friend Jacob Bernoulli, “Nature has established patterns which are the origin of the recurrence of events, but only for the most part.” After twenty years of study this led to Bernoulli's discovery of the “Law of Large Numbers” (“Ars Conjectandi”—The Art of Conjecturing, 1713). Jacob Bernoulli's theory for the a posteriori calculation of probabilities is empirical since it does not offer a method for organizing all the Discrete Sample Spaces mathematically and for allowing the theoretical probability of their events to be known a priori and exactly. Contrary to the popular idea, the law does not provide a method for validating observed facts, and which are nothing more than the incomplete representation of the total truth.
Step 3: In 1773, Abraham de Moivre expounded the structure of normal distribution—“the bell-shaped curve”—and discovered the concept of “standard deviation” (“the doctrine of chances”). De Moivre's success in solving these problems is one of the most important achievements in mathematics. Eighty-three years later, when studying geodetic measurements taken in Bavaria, Gauss reached the same conclusion. “A standard deviation of 2% is accepted by the majority of statisticians.”

In particular, the law defined by stage 2, the Law of Large Numbers, in essence, states that “in any sample, the difference between the value observed and its true value will decrease proportionally as the number of observations increases.” A mathematical explanation of the law is therefore necessary.

Discrete Sample Spaces—These are all possible outcomes of an experiment.

Experiment—Experiments are those acts which, when repeated constantly under the same conditions, produce individual results, which we are unable to predict. However, after a certain number of repetitions, a defined pattern or regularity will occur. This is the regularity which makes it possible to build an accurate mathematical model with which the experiment can be analyzed.

The lottery draw is an example of a random experiment.

A simple analysis of these three steps shows that the gap which exists has to do with the knowledge of the organization of Sample Spaces, since this is what will allow us to analyze the experiment (lottery draws) mathematically. This process is at present carried out using statistics based on observations which have no foundation.

Furthermore, many historians often refer to occasions when the target was narrowly missed—occasions when something very important almost happened, but for one reason or another failed to happen.

However, up until now there has been no methodology which organizes sample spaces in a way which is able to reveal, even in a simple way, the most obvious and repetitive positive facts in the world of experience: their patterns of behavior that demonstrate a logical coherence, because, in addition to indicating the patterns of behavior, it shows that the causes of the occurrence of the patterns are the patterns themselves. The models depend on patterns of behavior that, when quantified, reveal the Theoretical Probabilities and the entire sample space becomes viable.

The story of Pascal's Triangle is a notable example of this. Pascal and Fermat held the key to a systematic method of calculating probabilities of future events. Though they hadn't come all the way around, they inserted the key into the lock. Thus, it is clear that it was a simple game of chance “The Point Problem” that inspired Pascal and Fermat to formulate their laws of probability.

Furthermore, another example of application based on the generation of random numbers would be in quantum theory, as it deals with the random movement of elementary particles in a fundamental way, being in particular an intrinsically probabilistic theory, so the innovations introduced make it possible to understand and control of randomly generated numbers. Probabilistic mathematical model that allows understanding and controlling the movement of elementary particles that act in the microcosm, also generated randomly. It also represents to quantum mechanics what Newton's laws are to classical mechanics—it reveals the fundamental microscopic language of nature.

The “probabilistic mathematical model” provides the “Risk Domain.”

Document U.S. Pat. No. 7,565,263B2 presents a system for preparing templates in the form of tables. In the presented system, the grouping occurs according to the types of starts, which can confuse the user who is not familiar with the preparation of the templates.

However, up until now there has been no methodology which organizes sample spaces in a way which is able to reveal, even in a simple way, the most obvious and repetitive positive facts in the world of experience, or their behavior patterns, which demonstrate an extreme logical coherence, because in addition to indicating the patterns of behavior, it shows that the causes of the occurrence of the patterns are the patterns themselves.

Considering the foregoing, the state of the art would clearly benefit from the introduction of a mathematical model for the preparation of statistics and probabilistic templates for the best visualization of entertainment media based on random numbers in a simple and efficient way, for the development of a binary system to represent tens through initial numbers and colors. Therefore, each ten is associated with a color and its initial number, to create models that depend on behavior patterns, so when quantified, these models reveal the Theoretical Probabilities so that the entire sample space becomes viable.

### SUMMARY OF THE INVENTION

In order to solve the problems of the state of the art, it is an objective of this invention to present a statistics system for the preparation of templates, for revealing the movement of randomly generated numbers.

It is another objective of this invention to present an Organization of Discrete Sample Spaces, of Pascal's Triangle, which resulted in experiments Cn,p—simple combinations of n elements taken p to p—by their behavior patterns, with their theoretical probabilities determined at a priori and exactly, in addition to showing the mathematical innovations introduced in Pascal's formula—in the Law of Large Numbers and the discovery of the “behavior patterns” that made possible the construction of the Organization.

Another objective of this invention is to carry out a statistical control of movement, in which calculations and facts coincide to comply with the so-called Law of Large Numbers, in addition to a system that allows its control in real time, which makes it possible to make decisions.

Finally, it is one of the objectives of this invention to visualize entertainment media based on random numbers in a simple and efficient way, for that the development of a binary system to represent tens through initial numbers and colors is provided. To this end, each ten is associated with a color and its initial number.

### BRIEF DESCRIPTION OF THE INVENTION

In order to achieve the aforementioned objectives, this invention comprises a statistical generation system for preparing templates through a color convention.

Furthermore, the solution proposed by this invention is based on a methodology inspired by games of chance, such as lotteries, which are Pascal's Triangle experiments. Based on the principles of Combinatorial Analysis—Theory of Probabilities and Statistics, a methodology was created on “Organization of Sample Spaces,” Cn,p, based on its behavior patterns, which allows controlling the movement of randomly generated numbers, and its probabilistic mathematical model “Reveals the Language of Nature.”

Pascal's formula Cn,p is the mathematical core of the Theory of Probability. It only provides the number of combinations for each experiment Cn,p. Mathematical models depend on patterns of behavior and the organization of sample spaces by their patterns of behavior, in addition to calculating the same values as Pascal's formula, it allows one to analyze these experiments mathematically.

In particular, referring to the “Law of Large Numbers,” in any sample, the difference between the value observed and its true value will decrease proportionally as the number of observations increases. Jacob Bernoulli's theory for the calculation of a posteriori probabilities is empirical, since he does not provide a method to organize the entire Discrete Sample Space mathematically and allow the assessment of the theoretical probabilities of its events to be known a priori and exactly. The law does not provide a method for validating observed facts which are nothing more than the representation of the total truth. The solution suggested here is based on a methodology that organizes the Discrete Sample Spaces into patterns of behavior that allows us to calculate the theoretical probabilities of their a priori events that are obeyed in the extractions. Behavior patterns enshrine the Law of Large Numbers.

The Organization of Sample Spaces of Experiments Cn,p of Pascal's Triangle by its behavior patterns, with its theoretical probabilities determined a priori and exactly, is its probabilistic mathematical model, constituting the key to a systematic method of calculating the probability of future events.

More specifically, the logic of the method of this invention, a priori, is related to the structure of Sample Spaces, in which numbers are randomly drawn, form the behavior patterns and are placed in the extraction tables. The method of this invention analyzes in real time how the sample space is being formed every hundred extractions, that is, the behavior patterns, such as:
Which groups are being constructed according to their theoretical probabilities?
Which ones are being formed correctly?
Which ones are in excess?
Which ones are missing?
   so, in this way, the extraction tables provide us with real-time control of these events, that is, they provide us with the development of the formation of the sample space. It is this control that provides us with the so-called Risk Domain. Furthermore, the control is carried out every one hundred extractions, and the resulting samples show the same result.

Thus, the extraction tables provide us with real-time control of these events, that is, they provide us with the development of the formation of the sample space. It is this control that provides us with the Risk Domain.

The practical advantage of the solution proposed by this invention is the rationalization of information, allowing the taking of calculated decisions. With the use of colors to represent the patterns (or templates) it is possible to manage the entire system via computer, accessible, for example, by a user through the Internet.

In particular, one can see that the state of the art is based on the observation of past data, a criterion not allowed by the Law of Large Numbers, since these data do not express the whole truth.

The solution proposed by this invention is capable of constructive operational variables, as it is the result of a precise “mathematical and probabilistic model” and begins a new phase in our knowledge of the movement of things, and is liable to become a central tool in any activity that involves random movements, such as: genetics, finance, engineering, etc.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an example of a first table.

FIG. 2 is an example of a second table.

FIG. 3 is an example of a third table.

FIG. 4 is an example of a fourth table.

FIG. 5 is an example of fifth table.

FIG. 6 is an example of a sixth table.

FIG. 7 is an example of a seventh table.

FIG. 8 is an example of an eighth table.

FIG. 9 is an example of a ninth table.

FIGS. 10-22 is an example of a tenth table.

### DETAILED DESCRIPTION

In accordance with the objectives mentioned and the figures presented, this invention refers to a STATISTICS SYSTEM FOR PREPARING TEMPLATES, which comprises a Color Convention, Definitions (I-VIII) and Axioms (I-III). Next, the Color Convention of this invention is detailed.

Color Convention

One of the objectives of the method object of this invention is to visualize the games in a simple and efficient way. Therefore, a way to represent numbers through colors is proposed. Each decile is associated with a color and is given a name. The denomination of each decile is defined by its starting number, for example, the numbers 01, 02 and 09 are called numbers of decile zero (DO), decile one (D1), and so on.

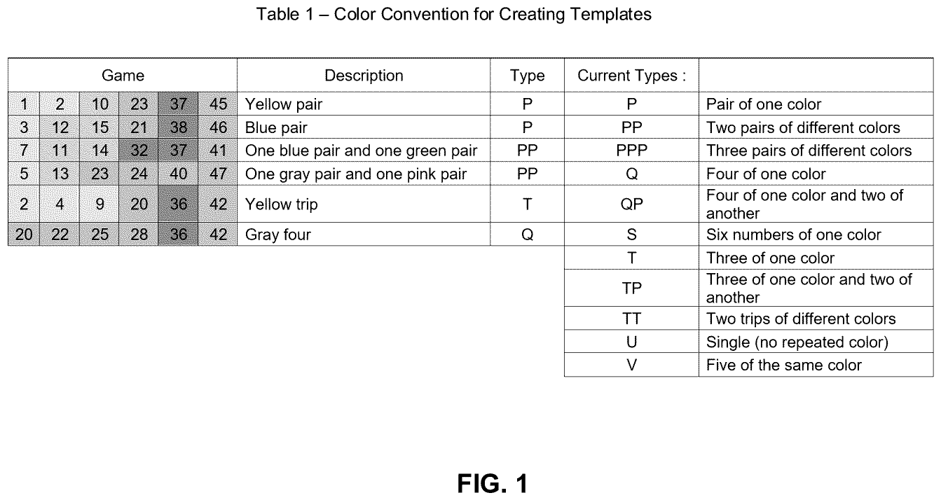

The present color convention uses the models as shown in Table 1 of FIG. 1.

One of the goals is to visualize the games in a simple and efficient way, for that, we developed a binary system to represent tens through initial numbers and colors. Thus, each ten is associated with a color and its starting number. For case study, lottery 6/48 will be used.

More specifically, this invention uses the solution of Pascal's Triangle, in particular the Organization of Sample Spaces of the experiments Cn,p by their behavior patterns with their theoretical probabilities determined a priori and exactly, probabilistic mathematical model of the movement of randomly generated numbers.

Furthermore, this invention completes the Combinatorial Analysis and the Theory of Probability, in order to provide a systematic method of calculating probabilities of future events.

The items of Combinatorial Analysis and Theory of Probability that enable the solution of this invention are listed below, through Definitions (I-VIII).

### Definition I

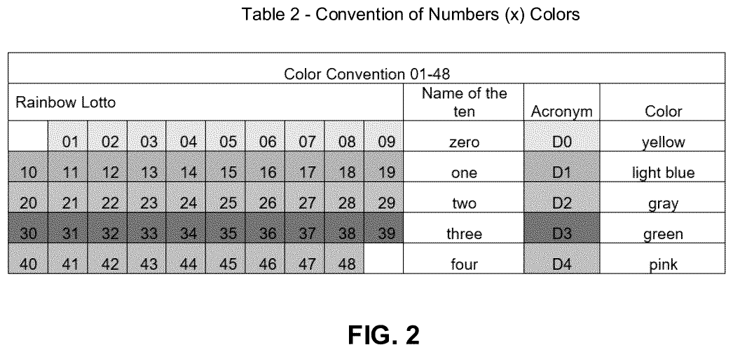

The tens are classified by their initial numbers, that is, by the first digit, referring to the unit, and each ten receives a color, as shown in Table 2 of FIG. 2. For the unit numbers (from 0 to 9), a leading zero is added (for example: 01, 02 . . . , 09) and, therefore, the classification of unit numbers follows the same convention as the tens, being defined by the first digit, referring to the number zero added to the left.

### Definition II

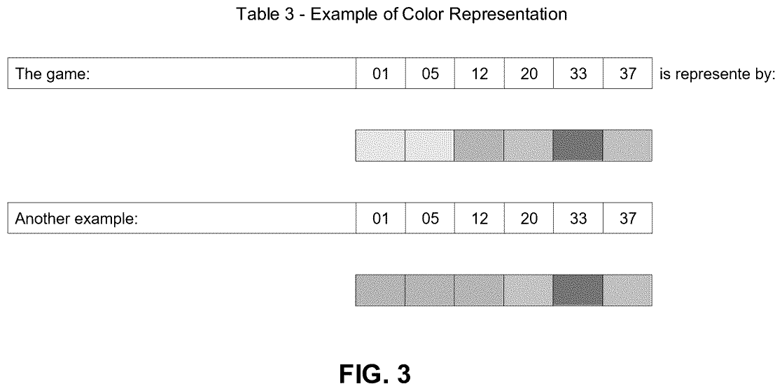

Each game will be represented by the colors corresponding to the numbers, pairs and trips that compose it, as shown in Table 3 of FIG. 3.

### Definition III

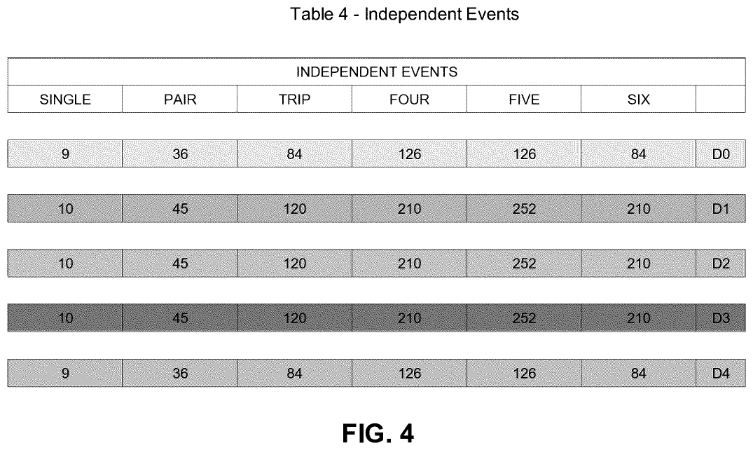

Independent Events—The numbers, pairs, trips, fours, fives, sixes of the same ten are the Independent Events thereof, as shown in Table 4 of FIG. 4.

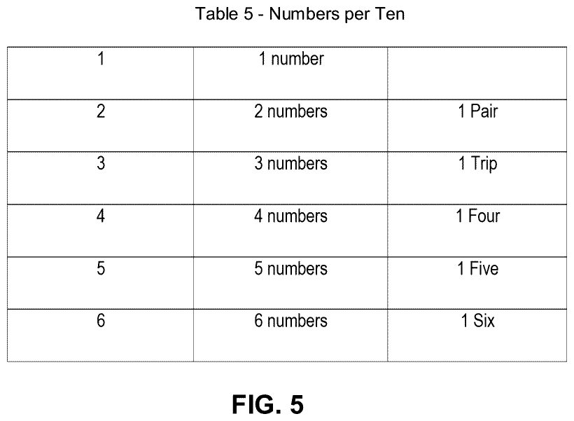

By marking six numbers, one can mark every ten, as shown in Table 5 of FIG. 5.

These events are called Independent Events.

Each ten has a number of numbers, so its Independent Events have the amounts corresponding to ten number thereof.

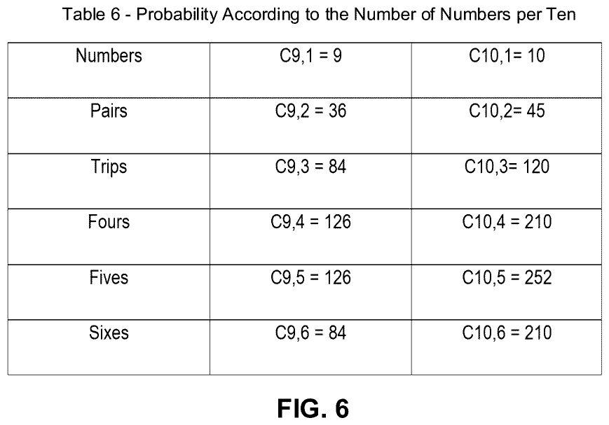

The tens of 0 and 4 have 9 numbers; 1-2-3 tens have 10 numbers, as shown in Table 6 of FIG. 6.

All values of the independent events used are found in the first ten lines of Pascal's Triangle.

### Definition IV

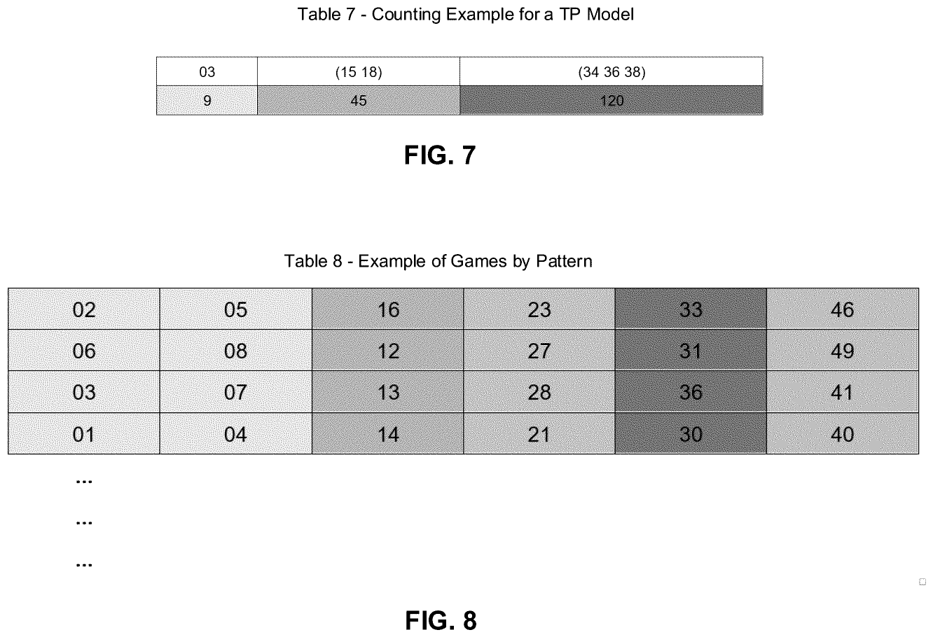

By the fundamental principle of counting, the possibility of simultaneous occurrence of two or more independent events is equal to the product resulting from the possibilities of the events that compose it. For example, with respect to Table 7 of FIG. 7, the producting result 48,600 games.

### Definition V

Behavior Pattern

It is a model that obeys the same ordered sequence of independent events totaling 6-p numbers. Each pattern has an exact number of games, as shown in Table 8 of FIG. 8.

In this example, the lottery is systematically played using the same pattern, where it is marked:
1 pair results in D0;
1 number results in D1;
1 number results in D2;
1 number results in D3;
1 number results in D4;
   wherein D0-D4 are as defined by Table 2.

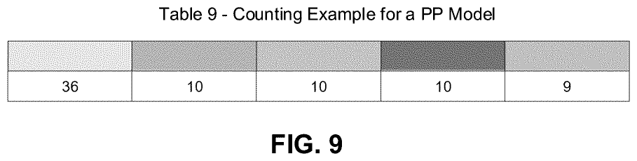

Table 9 of FIG. 9 illustrates counting examples for a PP model:

Organization of Sample Spaces

Using computer resources, all behavior patterns for all experiments Cn,p are obtained by orderly combining the independent events p to p (6 to 6).

### Definition VI

A—The sum of the number of games of all patterns totals exactly the games of the experiment.

### Definition VII

B—By dividing the number of games of each pattern by the total number of games in the experiment, the theoretical probabilities of all patterns determined a priori and exactly are obtained.

It is also obtained the organization of the sample spaces of all experiments Cn,p constituted in probabilistic mathematical models that allow one to study them mathematically.

If a series of repetitive experiments agree with a hypothesis, a law governing these experiments must be formulated.

Regarding the Risk Domain, it is specified that numbers are generated randomly, form the behavior patterns and are inserted in the extraction table (100 out of 100). The template number is placed in the column corresponding to its Group=Type×Start. The groups are repeated around the mean, in order to define the formation of sample spaces by the randomly generated numbers.

As the probabilities of the groups are fulfilled, we can format the results and it is this formatting that gives us the control, the domain of the movement of the randomly generated numbers.

The following are the Axioms (I-III) of this invention:

Axiom I

In combinatorial processes, numbers of the same ten are preliminarily combined with each other and form independent events.

Axiom II

Independent events arranged in the order p to p constitute the patterns of behavior.

Axiom III

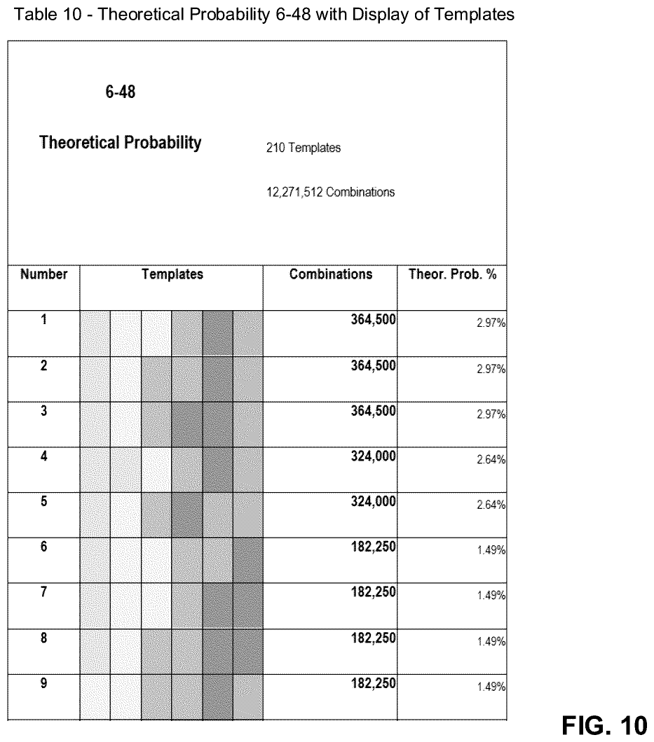

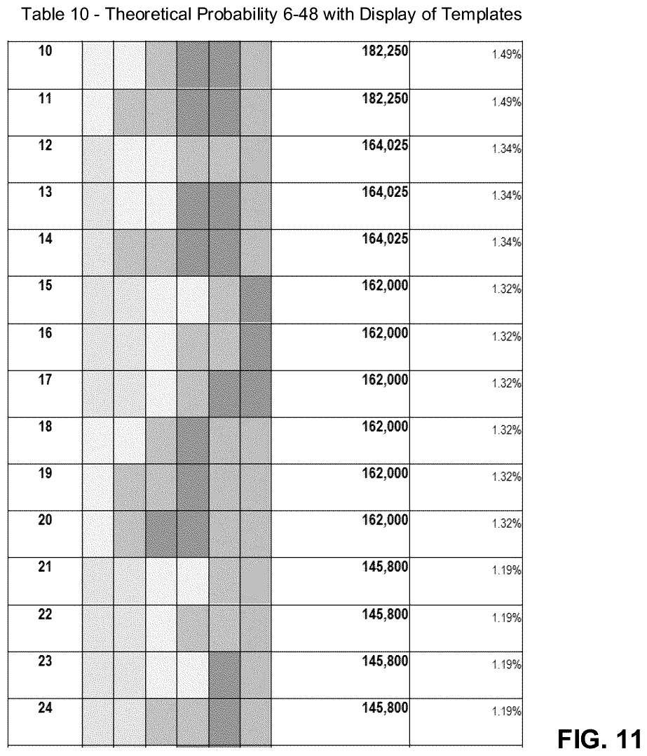

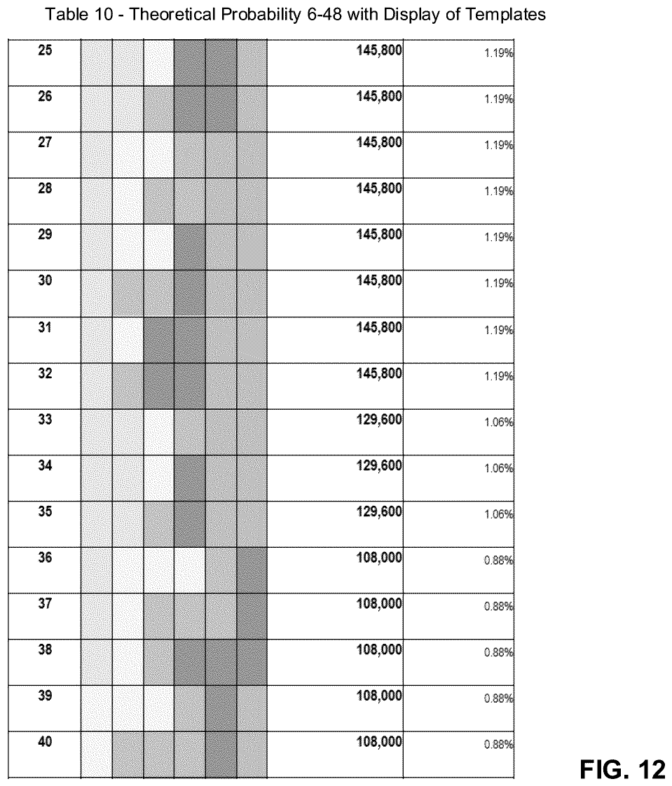

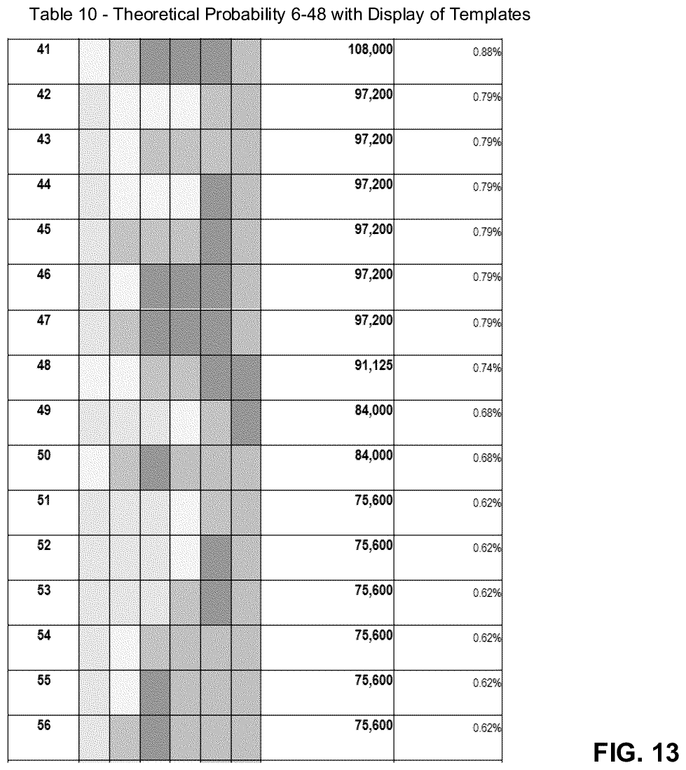

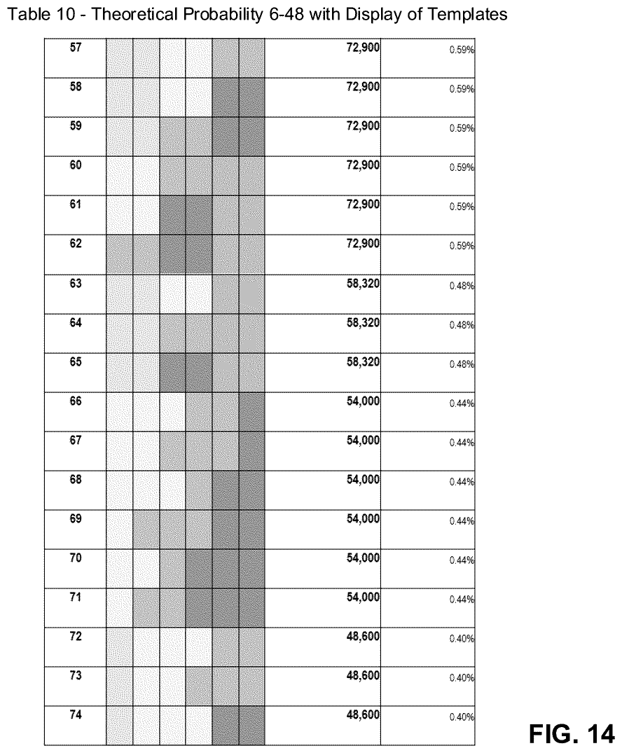

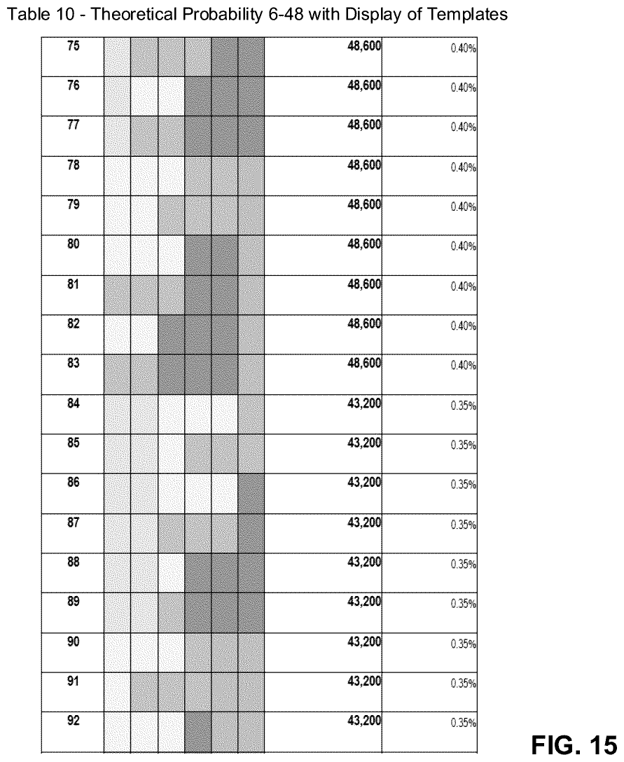

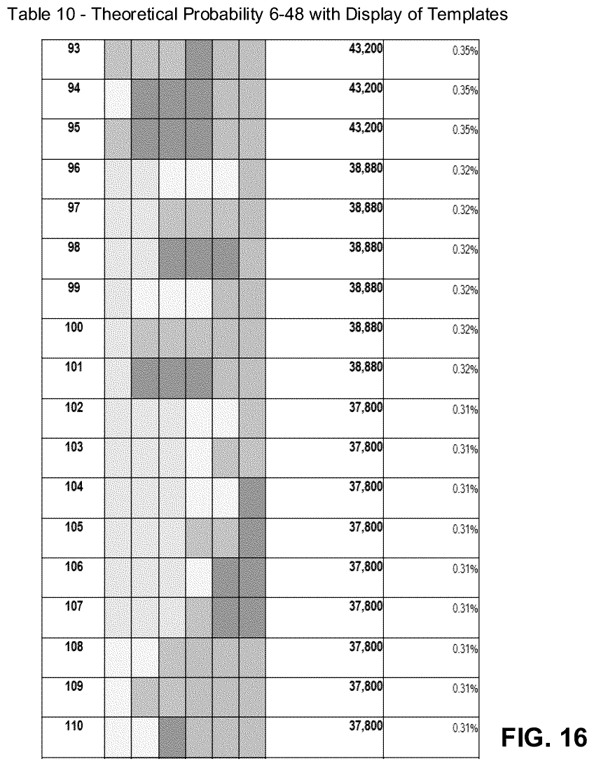

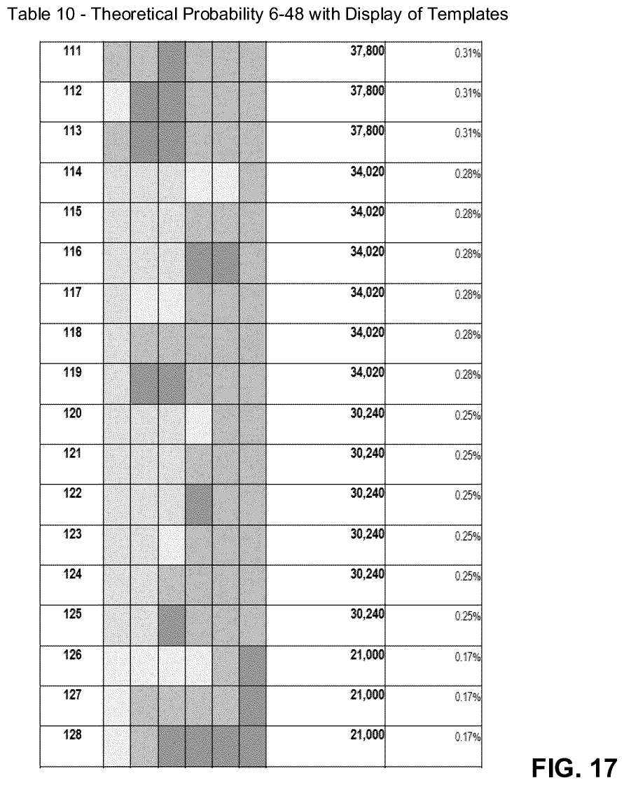

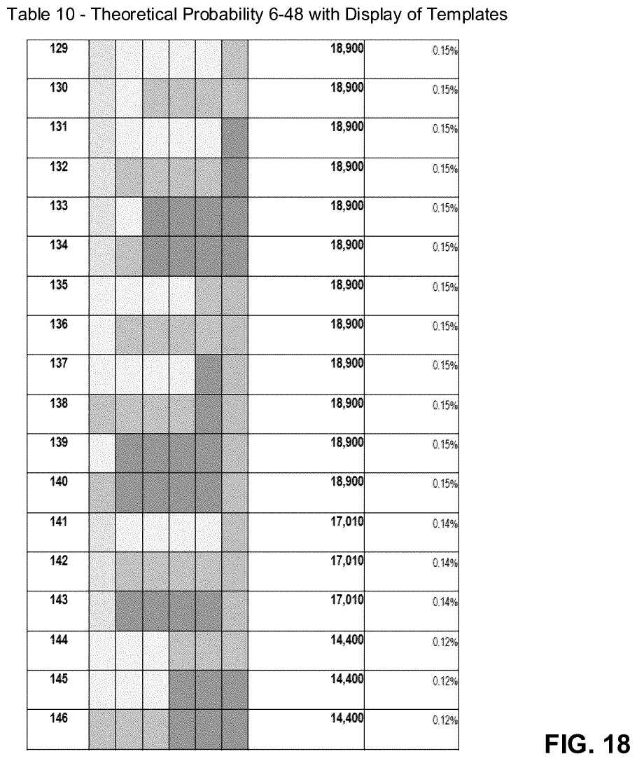

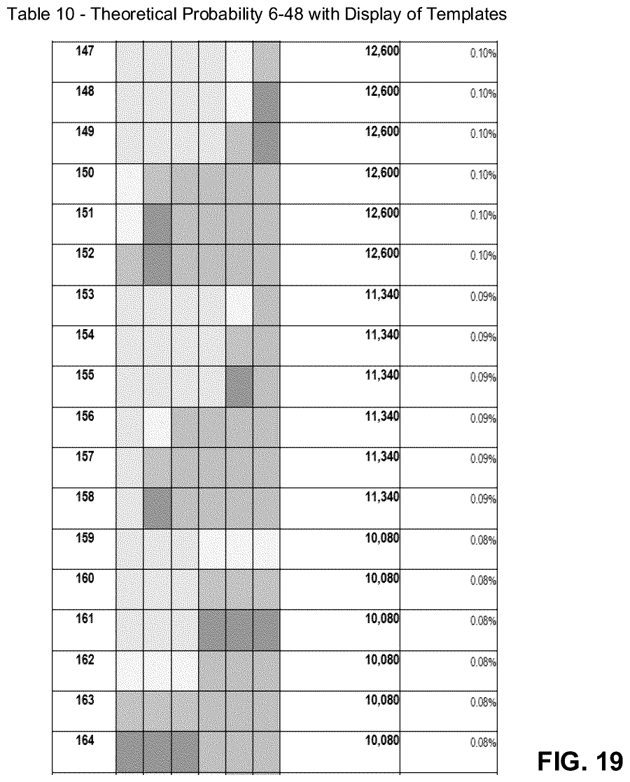

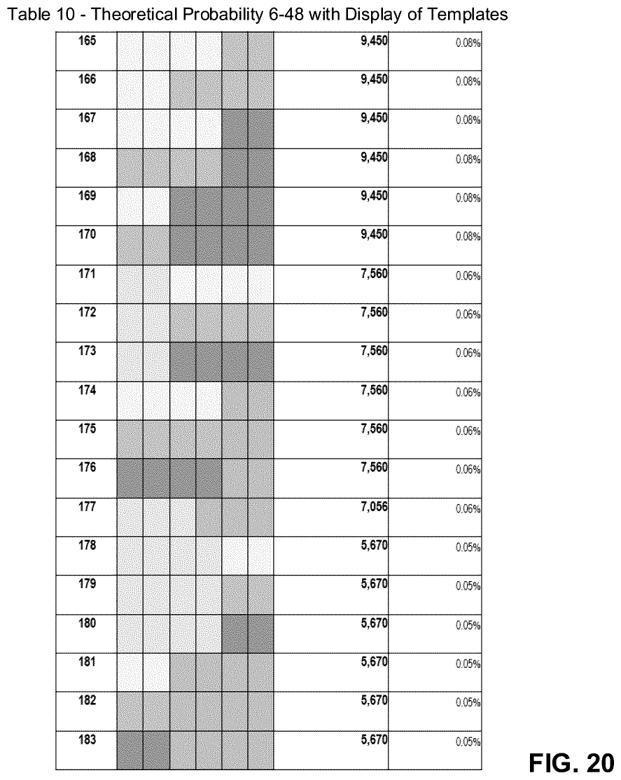

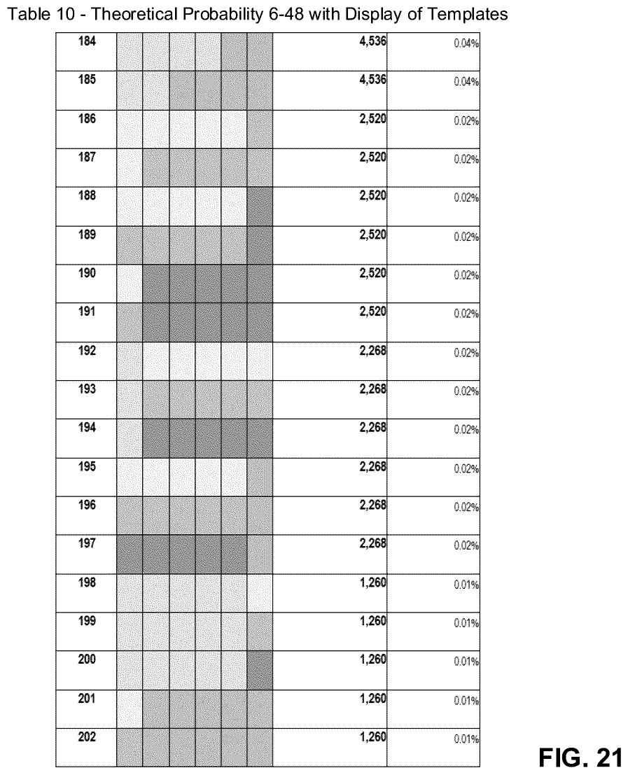

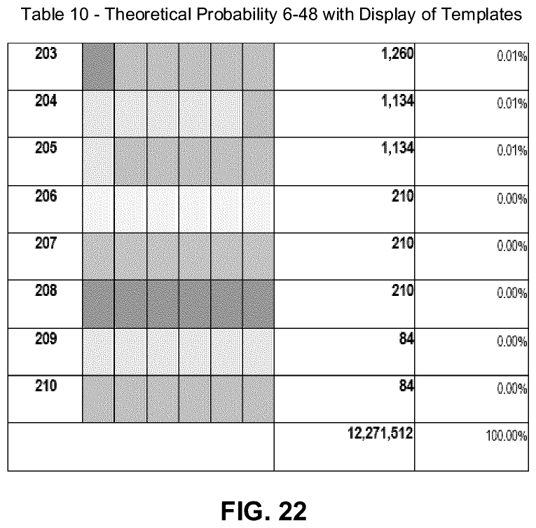

The set of behavior patterns constitutes for each experiment the organization of its sample spaces, as shown in Table 10 of FIGS. 10-22.

As described above, guessing numbers in entertainment based on random numbers is not just a matter of luck. By having access to computer generated templates, tools and tables, which are constantly updated, a user can create an imposing prediction related to the behavior pattern of, for example, lottery draws, based on mathematics and probabilities, presented in a format that visualizes the patterns and selections so that someone unfamiliar with math or probabilities can easily use the tools to select numbers for a lottery draw. By subscribing to the inventive system, the user has access to tables with behavior patterns for the specific lottery, game patterns with the respective draw probabilities and updated information according to the results of the draws.

With the presentation of the templates as shown in Table 10, the user is advantageously able to view the templates without the need to know their types in advance. Accordingly, the user has greater ease of choice and ease of application.

The solution of this invention can also be used in matters related to Quantum Theory, as this theory incorporates an element of randomness in a fundamental way, and is an intrinsically probabilistic theory, with elementary particles in particular being randomly generated.

It should be understood that this description does not limit the application to the details described herein and that the invention is capable of other embodiments and of being carried out or implemented in a number of ways within the scope of the claims. Although specific terms have been used, such terms should be interpreted in a generic and descriptive sense, and not for the purpose of limitation

1. A STATISTICS SYSTEM FOR PREPARING TEMPLATES, in particular for means performed by generating random numbers for prediction, such as a lottery draw, where a specific subset of numbers is selected from a defined set of numbers, characterized in that it comprises a color convention, definitions (I-VIII) and Axioms (I-III), which define a template for each type of means performed by generating random numbers, such as lottery games, said templates having subcategories separated by colors, as defined by said color convention.

2. The SYSTEM, according to claim 1, characterized in that the color convention uses the following models: associating each decile with a color and receiving a name, in which the denomination of each decile is defined by its initial number.

3. The SYSTEM, according to claim 1, characterized in that, in definition (I), the tens are classified by their initial numbers and each one receives a color.

4. The SYSTEM, according to claim 1, characterized in that, in definition (II), each game will be represented by the colors corresponding to the numbers, pairs and trips that compose it.

5. The SYSTEM, according to claim 1, characterized in that, in definition (III), Independent Events are the numbers, pairs, trips, fours, fives, sixes of the same ten, in which each ten has a quantity of numbers and the Independent Events have the amounts corresponding to the number of their ten, being that the tens of zero and four—have nine numbers; the tens of one, two and three—have ten numbers.

6. The SYSTEM, according to claim 1, characterized in that, in definition (IV), the possibility of simultaneous occurrence of two or more independent events is equal to the product resulting from the possibilities of the events that compose it.

7. The SYSTEM, according to claim 1, characterized in that, in definition (V), a model is presented that obeys the same ordered sequence of independent events totaling six-p numbers, in which each pattern has an exact number of games.

8. The SYSTEM, according to claim 1, characterized in that, in definition (VI), the sum of the number of games of all patterns totals exactly the games of the experiment.

9. The SYSTEM, according to claim 1, characterized in that, in definition (VII), by dividing the number of games of each pattern by the total number of games in the experiment, the theoretical probabilities of all patterns determined are obtained a priori and exactly, in order to obtain an organization of the sample spaces of all experiments Cn,p constituted in probabilistic mathematical models that allow one to study them mathematically.

10. The SYSTEM, according to claim 1, characterized in that the Axioms (I-III) of this invention define:
AXIOM I—In combinatorial processes, numbers of the same ten are preliminarily combined with each other and form independent events;
AXIOM II—Independent events arranged in the order p to p constitute the behavior patterns; and
AXIOM III—The set of behavior patterns constitute for each experiment the organization of its sample spaces.
